(19) United States
(12) Patent Application Publication
(10) Pub. No.: US 2023/0418670 A1
(43) Pub. Date: Dec. 28, 2023

(54) SERVICE PROCESSING METHOD AND APPARATUS, SERVER, STORAGE MEDIUM AND COMPUTER PROGRAM PRODUCT

(71) Applicant: TENCENT TECHNOLOGY (SHENZHEN) COMPANY LIMITED, Shenzhen (CN)

(72) Inventors: Shili XU, Shenzhen (CN); Yabin Fu, Shenzhen (CN); Bingwu ZHONG, Shenzhen (CN); Yulin HU, Shenzhen (CN); Yanhui LU, Shenzhen (CN); Xiaohu MA, Shenzhen (CN)

(73) Assignee: TENCENT TECHNOLOGY (SHENZHEN) COMPANY LIMITED, Shenzhen (CN)

(21) Appl. No.: 18/462,164

(22) Filed: Sep. 6, 2023

Related U.S. Application Data
(63) Continuation of application No. PCT/CN2022/106367, filed on Jul. 19, 2022.

(30) Foreign Application Priority Data
Aug. 2, 2021 (CN) 202110884435.7

(51) Int. Cl. G06F 9/48; G06F 9/38

(52) U.S. Cl. CPC G06F 9/4893; G06F 9/3877

(57) ABSTRACT

A service processing method includes determining a first computing power resource for executing an offline task, determining N edge servers which execute the offline task and on which cloud applications are running based on idle computing power resources of the N edge servers being greater than the first computing power resource, and scheduling the offline task to the N edge servers in a distributed mode while ensuring normal operation of the cloud applications, so that each edge server in the N edge servers executes the offline task using the idle computing power resource of the edge server.

### CROSS-REFERENCE TO RELATED APPLICATIONS

This application is a continuation application of International Application No. PCT/CN2022/106367, filed on Jul. 19, 2022, which claims priority to Chinese Patent Application No. 202110884435.7, filed with the China National Intellectual Property Administration on Aug. 2, 2021, the disclosures of each of which being incorporated by reference herein in their entireties.

### FIELD

The disclosure relates to the field of computer technologies, and in particular, to a service processing method and apparatus, a server, a storage medium, and a computer program product.

### BACKGROUND

A cloud application refers to a novel application of transforming the use of conventional software locally installed and locally calculated into an out of the box service, connecting and manipulating a remote server cluster through the Internet or local area network to complete logic or computing tasks. In simple terms, the cloud application refers to that the operation and computing of a certain application rely on execution of a cloud server, a terminal is only responsible for picture display, such as cloud gaming as a typical cloud application, the cloud gaming refers to that the game runs on a remote server based on cloud computing technology, the terminal does not need to download or install, and does not need to consider terminal configuration, which completely solves the problem that the terminal performance is insufficient to run heavy games.

In view of the above, the operation of cloud applications requires extremely low network delay and extremely high network stability, and the conventional network environment cannot meet the network requirements of cloud applications. Therefore, in order to provide users with a more stable network environment, it is common to deploy edge servers on a large scale to bring cloud application servers closer to the users. However, in order to provide better cloud application experience for the users, resources are prepared according to the maximum number of people online, regardless of the situation, and as a result, some resources are idle during off-peak hours, resulting in waste of resources. Therefore, in the field of cloud applications, how to avoid waste of resources and improve resource utilization has become an important topic.

### SUMMARY

According to various embodiments, a service processing method and apparatus, a server, a storage medium and a computer program product are provided.

A service processing method, performed by a computer device, including:
determining a first computing power resource for executing an offline task;
determining N edge servers configured to execute the offline task and on which cloud applications are running based on idle computing power resources of the N edge servers being greater than the first computing power resource, N being an integer greater than or equal to 1; and
scheduling the offline task to the N edge servers in a distributed mode while ensuring normal operation of the cloud applications, so that for each edge server in the N edge servers, the edge server executes the offline task using the idle computing power resource of the edge server.

A service processing apparatus, including: at least one memory configured to store program code; and at least one processor configured to access the at least one memory and operate according to the program code, the program code including:
determining code configured to cause at least one of the at least one processor to determine a first computing power resource for executing an offline task; and determine N edge servers configured to execute the offline task and on which cloud applications are running, based on idle computing power resources of the N edge servers being greater than the first computing power resource, N being an integer greater than or equal to 1; and
   scheduling code configured to cause at least one of the at least one processor to schedule the offline task to the N edge servers in a distributed mode while ensuring normal operation of the cloud applications, so that for each edge server in the N edge servers, the edge server executes the offline task using the idle computing power resource of the edge server.

A non-transitory computer-readable storage medium, storing computer code which, when executed by at least one processor, causes the at least one processor to implement the service processing method provided in some embodiments.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic structural diagram of a cloud application management system according to some embodiments.

FIG. 2 is a schematic flowchart of a service processing method according to some embodiments.

FIG. 3 is a schematic flowchart of another service processing method according to some embodiments.

FIG. 4 is a schematic structural diagram of a service processing system according to some embodiments.

FIG. 5 is a schematic structural diagram of a service processing apparatus according to some embodiments.

FIG. 6 is a schematic structural diagram of another service processing apparatus according to some embodiments.

FIG. 7 is a schematic structural diagram of a server according to some embodiments.

FIG. 8 is a schematic structural diagram of another server according to some embodiments.

### DETAILED DESCRIPTION

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure and the appended claims.

Some embodiments provide a service processing method, performed by a computer device, comprising: determining a first computing power resource required to execute an offline task; determining N edge servers configured to execute the offline task, cloud applications running on the N edge servers; idle computing power resources of the N edge servers being greater than the first computing power resource, the idle computing power resources of the N edge servers referring to a sum of idle computing power resources of edge servers in the N edge servers, and N being an integer greater than or equal to 1; and scheduling the offline task to the N edge servers in a distributed mode, so that each edge server in the N edge servers executes the offline task by using the idle computing power resource of the each edge server while ensuring normal operation of the cloud applications.

Some embodiments provide a service processing method, executed by an edge server in N edge servers configured to execute an offline task, cloud applications running on the N edge servers, the service processing method including: receiving a distributed offline task scheduled by a management server in a distributed mode, the distributed offline task including the offline task received by the management server; or the distributed offline task including a subtask in N subtasks matching the edge server, and the N subtasks being obtained by performing division processing on the offline task based on an idle computing power resource of each edge server in the N edge server; and executing the distributed offline task by using the idle computing power resource of the edge server while ensuring normal operation of the cloud applications.

Some embodiments provide a service processing apparatus, including: at least one memory configured to store program code; and at least one processor configured to access the at least one memory and operate according to the program code, the program code including: determining code configured to cause at least one of the at least one processor to determine a first computing power resource required to execute an offline task; and determine N edge servers configured to execute the offline task, cloud applications running on the N edge servers; idle computing power resources of the N edge servers being greater than the first computing power resource, the idle computing power resources of the N edge servers referring to a sum of idle computing power resources of edge servers in the N edge servers, and N being an integer greater than or equal to 1; and scheduling code configured to cause at least one of the at least one processor to schedule the offline task to the N edge servers in a distributed mode, so that each edge server in the N edge servers executes the offline task by using the idle computing power resource of the each edge server while ensuring normal operation of the cloud applications.

Some embodiments provide a service processing apparatus, including: at least one memory configured to store program code; and at least one processor configured to access the at least one memory and operate according to the program code, the program code including: receiving code configured to cause at least one of the at least one processor to receive a distributed offline task scheduled by a management server in a distributed mode, the distributed offline task including an offline task received by the management server, or the distributed offline task including a subtask in N subtasks matching the edge server, and the N subtasks being obtained by performing division processing on the offline task based on an idle computing power resource of each edge server in the N edge server; and the N edge servers being configured to execute the offline task, and cloud applications running on the N edge servers; and execution code configured to cause at least one of the at least one processor to execute the distributed offline task by using the idle computing power resource of the edge server while ensuring normal operation of a target cloud application.

Some embodiments provide a server, including: a processor, configured to implement one or more computer-readable instructions; and a computer storage medium, storing one or more computer-readable instructions, the one or more computer-readable instructions being loaded and executed by the processor for: determining a first computing power resource required to execute an offline task; determining N edge servers configured to execute the offline task, cloud applications running on the N edge servers; idle computing power resources of the N edge servers being greater than the first computing power resource, the idle computing power resources of the N edge servers referring to a sum of idle computing power resources of edge servers in the N edge servers, and N being an integer greater than or equal to 1; and scheduling the offline task to the N edge servers in a distributed mode, so that each edge server in the N edge servers executes the offline task by using the idle computing power resource of the each edge server while ensuring normal operation of the cloud applications.

Some embodiments provide a server, including: a processor, configured to implement one or more computer-readable instructions; and a computer storage medium, storing one or more computer-readable instructions, the one or more computer-readable instructions being loaded and executed by the processor for: receiving a distributed offline task scheduled by a management server in a distributed mode, the distributed offline task including the offline task received by the management server; or the distributed offline task including a subtask in N subtasks matching an edge server in N edge servers, and the N subtasks being obtained by performing division processing on the offline task based on an idle computing power resource of each edge server in the N edge server; and executing the distributed offline task by using the idle computing power resource of the edge server while ensuring normal operation of cloud applications running on the N edge servers.

Some embodiments provide a non-transitory computer-readable storage medium, storing computer code which, when executed by at least one processor, causes the at least one processor to implement the service processing method provided in some embodiments.

In some embodiments, the computer-readable instruction, when executed by the processor, is used for executing the service processing method provided in some embodiments.

Some embodiments provide a computer program product or a computer-readable instruction, the computer program product including a computer-readable instruction, and the computer-readable instruction being stored in a computer storage medium. A processor of a server reads the computer-readable instruction from the computer storage medium, and the processor executes the computer-readable instruction, so that the server executes the service processing method provided in some embodiments.

In some embodiments, the processor of the server reads the computer-readable instruction from the computer storage medium, and the processor executes the computer-readable instruction, so that the server executes the service processing method provided in some embodiments

Various embodiments provide a service processing solution that can make full use of resources of edge servers, improve the resource utilization, and at the same time reduce the operating costs of the edge servers of cloud applications. In the service processing solution, in a case that a management server receives an offline task to be executed, a first computing power resource required to execute the offline task may be evaluated, and N edge servers configured to execute the offline task are then determined. It is to be illustrated that idle computing power resources of the N edge server are greater than the first computing power resource. The offline task is then scheduled to the N edge servers in a distributed mode, so that the N edge servers execute the offline task by using respective idle computing power resources while ensuring normal operation of the cloud applications. The value of N may be greater than or equal to 1. In a case that the value of N is 1, distributed scheduling refers to allocating the offline task to an edge server for separate execution. In a case that the value of N is greater than 1, distributed scheduling refers to allocating the offline task to a plurality of edge servers for collective execution, the offline task may be divided into several subtasks, and each edge server is allocated to execute a subtask. In this way, a load of each edge server may be shared, to ensure normal operation of a cloud application in each edge server. In some embodiments, the offline task may also be respectively allocated to each edge server, and the plurality of edge servers execute the same offline task, which may improve the execution rate of the offline task. The service processing solution provided by some embodiments can execute the offline task by using the idle computing power resource in each edge server while ensuring normal operation of the cloud applications during peak or off-peak hours of the cloud applications, which avoids the waste of computing power resources in each edge server, improves the utilization of computing power resources, and thus reduces the operating costs of the edge server.

In the following description, the terms “some embodiments” and “various embodiments” describes subsets of all possible embodiments, but it is to be understood that “some embodiments” and “various embodiments” may be the same subset or different subsets of all the possible embodiments, and can be combined with each other without conflict.

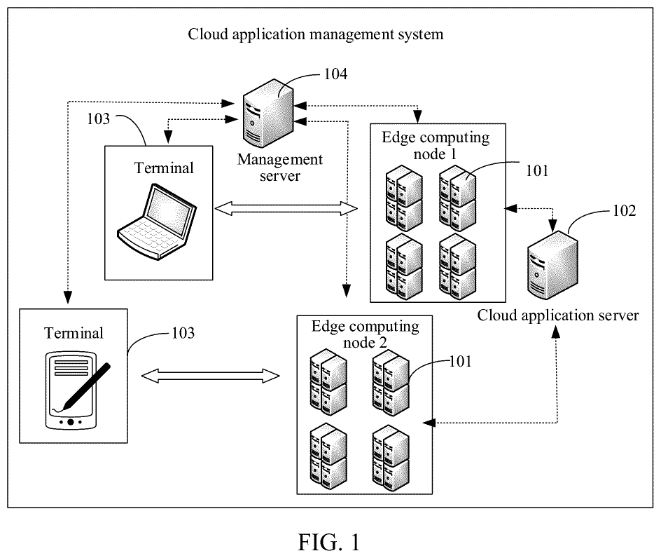

FIG. 1 is a schematic structural diagram of a cloud application management system according to some embodiments. The cloud application management system as shown in FIG. 1 includes at least one edge server 101. At least one edge server 101 may be configured to run cloud applications. It is to be illustrated that at least one edge server 101 may run the same or different cloud applications. Common cloud applications include cloud gaming, cloud education, cloud conferencing, and cloud social, etc.

In some embodiments, at least one edge server 101 may be allocated to a plurality of edge computing nodes. An edge computing node may be regarded as a node for edge computing. Edge computing may refer to an open platform that integrates the core capabilities of network, computing, storage, and application on the side close to an object or data source, and provides the nearest end services nearby, and application programs are initiated on the edge, faster network service responses are generated, and the basic requirements of the industry in real-time services, application intelligence, security and privacy protection and other aspects are met. Each edge computing node runs one or more edge servers, which have graphics processing computing power, and each edge server may be referred to as a computing node. In some embodiments, in FIG. 1, an edge computing node 1 includes four edge servers, and an edge computing node 2 may also include four edge servers.

In some embodiments, the cloud application management system as shown in FIG. 1 may further include a cloud application server 102. The cloud application server 102 is connected to at least one edge server 101. The cloud application server 102 may provide operating data of cloud applications for each edge server 101, so that each edge server 101 may run the cloud applications based on the operating data provided by the cloud application server.

In some embodiments, the cloud application management system as shown in FIG. 1 may also include a terminal 103. The terminal 103 may be connected to at least one edge server 101. The terminal 103 is configured to receive and display a picture obtained by rendering the cloud application by the edge server 101, in some embodiments, the terminal 103 displays a game picture obtained by rendering by the edge server 101. The terminal 103 may refer to a mobile intelligent terminal, which refers to a device with rich human-computer interaction modes, Internet access capabilities, usually equipped with various operating systems, and stronger processing capabilities. The terminal 103 may include a smartphone, a tablet computer, a notebook computer, a desktop computer, a smart loudspeaker, a smartwatch, an on board terminal, and a smart TV, etc.

In some embodiments, the cloud application management system as shown in FIG. 1 may also include a management server 104. The management server 104 is connected to the terminal 103 and at least one edge server 101, respectively. The management server 104 may be configured to manage and schedule at least one edge server 101. In some embodiments, in a case of monitoring that any cloud application is enabled in any terminal, the management server 104 may select one or more suitable edge servers to execute the cloud application enabled in any terminal according to the current load of each edge server 101 and idle computing power resources. In some embodiments, in a case that a user submits an offline task to the management server 104, the management server 104 determines to schedule the offline task to one or more edge servers 101 according to the idle computing power resource of each edge server, and one or more edge servers 101 allocated with the offline task execute the allocated offline task by using respective idle computing power resources while ensuring the normal operation of respective cloud applications. In this way, the normal operation of the cloud applications is ensured, the waste of idle computing power resources running the cloud applications is avoided, and the resource utilization of each edge server is improved, thereby reducing the operating costs of edge servers.

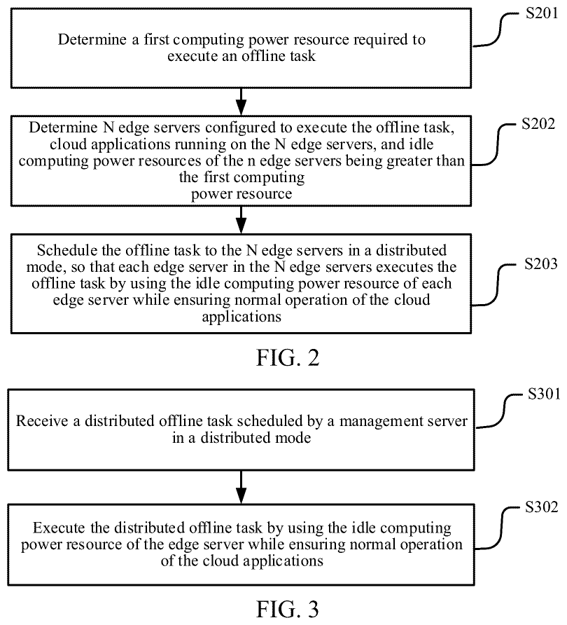

FIG. 2 is a schematic flowchart of a service processing method according to some embodiments. The service processing method as shown in FIG. 2 may be executed by a management server, specifically by a processor of the management server. The service processing method as shown in FIG. 2 may include the following operations:

Operation S201: Determine a first computing power resource required to execute an offline task.

The offline task refers to a task that does not need to be completed online in real time, such as offline rendering of video special effects and offline training of artificial intelligence models.

In some embodiments, the first computing power resource is different according to different types of main loads executing the offline task. In some embodiments, in a case that the main load executing the offline task belongs to the Graphics Processing Unit (GPU) type, that is, the main load executing the offline task is concentrated on the GPU, the first computing power resource may include any one or more of the following: a network bandwidth, an internal memory, Floating-point Operations Per Second (FLOPS) of the GPU, Operations Per Second (OPS) of the GPU, and a throughput.

In a case that the main load executing the offline task belongs to the Central Processing Unit (CPU) type, that is, the main load executing the offline task is concentrated on the CPU, the first computing power resource may include any one or more of the following: an internal memory, a network bandwidth, a FLOPS of the CPU, and an OPS of the CPU. In a case that the main load executing the offline task is a mixed type, that is, the load executing the offline task requires both the CPU and the GPU, then the first computing power resource is a combination of the first computing power resources under the above two types.

The FLOPS may be divided into half-precision, single-precision and double-precision. In a case of calculating the FLOPS of the GPU, it is necessary to calculate a half-precision FLOPS of the GPU, a single-precision FLOPS of the GPU, and a double-precision FLOPS of the GPU, respectively. Similarly, in a case of calculating the FLOPS of the CPU, it is also necessary to calculate a half-precision FLOPS of the CPU, a single-precision FLOPS of the CPU, and a double-precision FLOPS of the CPU, respectively. In the current standard for measuring the computing capability using FLOPS, teraFLOPS (TFLOPS), gigaFLOPS (GFLOPS), megaFLOPS (MFLOPS), petaFLOPS (PFLOPS) and the like are generally included.

In the current standard for measuring the computing capability using OPS, Million Operation Per Second (MOPS), Giga Operations Per Second (GOPS), Tera Operations Per Second (TOPS) and the like are generally included.

In some embodiments, the first computing power resource required to execute the offline task may be estimated based on a computing power resource used in the execution of a historical offline task similar to the offline task. In some embodiments, the determining a first computing power resource required to execute an offline task may include: determining a computation complexity corresponding to a task type of the offline task based on a correspondence between the task type and the computation complexity; finding at least one matching historical offline task from historical offline tasks according to the determined computation complexity, a computation complexity corresponding to each matching historical offline task matching the determined computation complexity; and estimating a computing power resource required for the offline task based on a computing power resource used for executing each matching historical offline task, to obtain a first computing power resource required to execute the offline task.

Tasks may be classified according to different task content. In some embodiments, the task content is to render an offline video, then the task type may be a video rendering type. In some embodiments, the task content is to train a model, then the task type may be a model training type. The computation complexity may also be referred to as an algorithm complexity. The algorithm complexity refers to resources required by an algorithm after it is written into an executable program, and the resources required include a time resource and an internal memory resource. The time resource may be measured through the FLOPS and the OPS. In some embodiments, executing the offline task is essentially executing the offline task written into an executable program.

The correspondence between task type and computation complexity may be determined by a computation complexity of executing the historical offline task, such as a computation complexity corresponding to the execution of a model training task and a computation complexity corresponding to an offline video rendering task. The computation complexity corresponding to the task type may be used for reflecting the order of magnitude of the complexity of executing the task type.

In some embodiments, the finding at least one matching historical offline task from historical offline tasks according to the determined computation complexity may include: finding historical offline tasks with the computation complexity matching the determined computation complexity from each historical offline task, and determining these historical offline tasks as the matching historical offline task. Matching of two computation complexities may be that a complexity difference between the two computation complexities is less than a certain specified value. It is to be illustrated that In the executed historical offline tasks, in addition to the historical offline task with a same task type as the offline task having a matching computation complexity with the offline task, the historical offline task with a different task type from the offline task may also have a matching computation complexity with the offline task. Therefore, in a case of determining the matching historical offline task, the matching historical offline task is not selected based on the task type to which the offline task belongs, but is selected according to the computation complexity corresponding to the offline task. In this way, more matching historical offline tasks may be selected from the historical offline tasks, and in a case of estimating the computing power resource required by the offline task based on the computing power resources used by these matching historical offline tasks, the estimated first computing power resource is more accurate.

Certainly, in practical applications, it is also possible to find historical offline tasks of a same task type as the offline task from each historical offline task as matching historical offline tasks, and it is estimated based on computing power resources used by these matching historical offline tasks to obtain the first computing power resource, which is not specifically limited herein, and may be flexibly selected according to actual needs.

In view of the above, the first computing power resource may include any one or more of a GPU computing power resource, a CPU computing power resource, an internal memory, a network bandwidth, and a network throughput. The estimating a computing power resource required for the offline task based on a computing power resource used for executing each matching historical offline task, to obtain a first computing power resource required to execute the offline task may include: estimating a corresponding computing power resource required for the offline task based on each computing power resource used for executing each matching historical offline task. In some embodiments, a graphics computing power resource required to execute the offline task is estimated based on a graphics computing power resource used for executing each matching historical task. In some embodiments, an internal memory required to execute the offline task is estimated based on an internal memory resource used for executing each matching historical task.

In some embodiments, the estimating a computing power resource required for the offline task based on a computing power resource used for executing each matching historical offline task, to obtain a first computing power resource required to execute the offline task may include: performing an averaging operation on computing power resources used for executing each matching historical offline task. The operation result is used as the first computing power resource required to execute the offline task.

In other embodiments, the estimating a computing power resource required for the offline task based on a computing power resource used for executing each matching historical offline task, to obtain a first computing power resource required to execute the offline task includes: allocating a weight value for each matching historical offline task according to a relationship between the task type of each matching historical offline task and the task type of the offline task, and performing a weighted averaging operation on at least one matching historical offline task based on the weight value of each matching historical offline task, the operation result being used as the first computing power resource required to execute the offline task. In some embodiments, in response to a matching historical offline task having a same task type as the offline task, a higher weight value may be assigned to the matching historical offline task, and in response to a matching historical offline task and the offline task belonging to different task types respectively, a lower weight value may be assigned to the matching historical offline task.

In some embodiments, the offline task may correspond to an execution duration threshold, and the first computing power resource required to execute the offline task may specifically refer to the first computing power resource required to execute the offline task in the execution duration threshold. The execution duration threshold is different, and the first computing power resource may be different.

Operation S202: Determine N edge servers configured to execute the offline task, cloud applications running on the N edge servers, and idle computing power resources of the N edge servers being greater than the first computing power resource.

It is to be illustrated that the cloud application is deployed to M edge servers to run, that is, M edge servers participate in the running of the cloud application. The N edge servers in operation S202 are selected from the M edge servers. In a case of selecting N edge servers from the M edge servers for executing the offline task, it is determined directly based on the idle computing power resource of each edge server in the M edge servers and the first computing power resource. The idle computing power resource of each edge server may be determined based on a second computing power resource required to run the cloud application in the edge server and a total computing power resource of the edge server. The second computing power resource required to run the cloud application in each edge server may also be estimated and determined by the management server based on the computing power resource used for running the cloud application historically. In some embodiments, the management server may obtain the computing power resources used for running the cloud application many times in history, and then average these computing power resources to estimate the second computing power resource required by the edge server to run the cloud application. It is to be understood that, in view of the above, the computing power resources may include a variety of computing power resources, and in a case of determining each computing power resource, each computing power resource required to run the cloud application each time is averaged to obtain the computing power resource required by the edge server to run the cloud application.

In some embodiments, N is an integer greater than or equal to 1. In a case that N is equal to 1, any edge server with an idle computing power resource greater than the first computing power resource may be selected from M edge servers as an edge server for executing the offline task.

In a case that N is greater than 1, in some embodiments, the determining N edge servers configured to execute the offline task includes: comparing an idle computing power resource of each edge server in the M edge servers with the first computing power resource; and determining N edge servers with idle computing power resources greater than the first computing power resource as N edge servers configured to execute the offline task. The idle computing power resource in each edge server may be determined based on the total computing power resource of each edge server and the second computing power resource required to run the cloud application. In some embodiments, the idle computing power resource of each edge server is obtained by subtracting the second computing power resource from the total computing power resource of each edge server. In some embodiments, the idle computing power resource of each edge server is obtained by adding the second computing power resource required by each edge server to run the cloud application with a reserved computing power, and then subtracting the addition result from the total computing power resource of each edge server. The purpose of this is to reserve some computing power resources for the running of the cloud application, so as to avoid the edge server being unable to respond in time when the computing power resources required by the cloud application suddenly increase, reducing the running speed and response efficiency of the cloud application.

In simple terms, the method for determining N edge servers includes: taking all edge servers with idle resources greater than the first computing power resource in the M edge servers as N edge servers for executing the offline task. Although the idle computing power resource of each edge server in the N edge servers are sufficient to make each edge server execute the offline task independently, in some embodiments, the offline task may be scheduled to the N edge servers in a distributed mode for collective execution, so that the first computing power resource required for the offline task may be distributed to different edge servers, and each edge server may reserve some excess computing power resources. In this way, in a case that the computing power resource required by the cloud application in a certain edge server increases, it can be ensured that the edge server allocates the reserved computing power to the cloud application in time while not suspending the execution of the offline task.

In some embodiments, the determining N edge servers configured to execute the offline task includes: comparing an idle computing power resource of each edge server in M edge servers with the first computing power resource; in a case that there is no edge server with a computing power resource greater than the first computing power resource; combining the M edge servers to obtain a plurality of combinations, each combination including at least two edge servers; and calculating a sum of idle computing power resources of the combinations, and determining edge servers included in the combinations with a sum of idle computing power resources greater than the first computing power resource as N edge servers configured to execute the offline task. That is, in a case that there is no edge server with an idle computing power resource greater than the first computing power resource in the M edge servers, a sum of the idle computing power resources of the selected N edge servers is greater than the first computing power resource.

In some embodiments, the M edge servers may be allocated to P edge computing nodes. Each edge computing node includes one or more edge servers. In some embodiments, P edge computing nodes include an edge computing node 1 and an edge computing node 2. The edge computing node 1 may include 5 edge servers, and the edge computing node 2 may include M-5 edge servers.

On this basis, in a case of determining N edge servers configured to execute the offline task from the M edge servers, L edge computing nodes may be determined from P edge computing nodes, node idle computing power resources of the L edge computing nodes are greater than the first computing power source, and N edge servers are selected from the determined L edge computing nodes. In some embodiments, the determining N edge servers configured to execute the offline task includes the following operations:

S1: Select L edge computing nodes from the P edge computing nodes, node idle computing power resources of the L edge computing nodes being greater than the first computing power resource.

The node idle computing power resources of the L edge computing nodes are a sum of node idle computing power resources of edge computing nodes in the L edge computing nodes, and the node idle computing power resources of L edge computing nodes being greater than the first computing power resource may include any one of the following situations: a node idle computing power resource of each edge computing node in the L edge computing nodes is greater than the first computing power resource, node idle computing power resources of some edge computing nodes in the L edge computing nodes are greater than the first computing power resource, a sum of node idle computing power resources of the remaining edge computing nodes is greater than the first computing power resource, and the node idle computing power resources of edge computing nodes in the L edge computing nodes are less than the first computing power resource, but the sum of node idle computing power resources of the L edge computing nodes is greater than the first computing power resource.

In simple terms, in a case of selecting L edge computing nodes from P edge computing nodes, only some edge computing nodes with idle computing power resources greater than the first computing power resource may be selected. In some embodiments, edge computing nodes with node idle computing power resources greater than the first computing power resource may be selected, and edge computing nodes with a sum of some node idle computing power resources greater than the first computing power resource may also be selected. In some embodiments, in a case that there is no edge node with a node idle computing power resource greater than the first computing power resource in P edge computing nodes, only some edge computing nodes with a sum of node idle computing power resources greater than the first computing power resource may be selected.

The node idle computing power resource for each edge computing node is determined based on the idle computing power resource of each edge server included in each edge computing node. In some embodiments, the idle computing power resources of a plurality of edge servers included in an edge computing node are added to obtain a node idle computing power resource of the edge computing node. In some embodiments, the idle computing power resources of a plurality of edge servers included in an edge computing node are averaged to obtain a node idle computing power resource of the edge computing node. It is to be illustrated that some embodiments only list two ways of calculating the node idle computing power resource. In specific applications, the node idle computing power resource may be calculated in any ways according to actual needs, which is not specifically limited herein.

S2: Determine at least one candidate edge server from edge servers included in the L edge computing nodes based on attribute information of each edge server included in the L edge computing nodes.

In some embodiments, the attribute information of each edge server may include the working state of each edge server. The working state may include an idle state or a busy state. In a case that the load of an edge server exceeds an upper load limit, the working state of the edge server is determined as the busy state. In some embodiments, in a case that the load on an edge server is less than an upper load limit, the working state of the edge server is the idle state. The edge server in the busy state is not scheduled to execute the offline task, and the edge server in the idle state may be scheduled for the offline task. Therefore, the determining a plurality of candidate edge servers from edge servers included in the L edge computing nodes based on attribute information of each edge server included in the L edge computing nodes includes: determining an edge server with the working state being the idle state in the edge servers included in the L edge computing nodes as a candidate edge server.

In some embodiments, the attribute information of each edge server includes a server type group to which each edge server belongs. The server type group includes a default whitelist group and an ordinary group. An edge server in the default whitelist group is configured to run high-priority, uninterrupted real-time cloud applications, so the edge servers in the default whitelist group is not scheduled for the offline task. An edge server in the ordinary group may be scheduled for the offline task. The edge server in the default whitelist group is dynamically changing. In a case that a certain edge server in the default whitelist group no longer executes a high-priority, uninterrupted real-time task, the edge server is removed from the default whitelist group and may be transferred to the ordinary group. Therefore, the determining a plurality of candidate edge servers from edge servers included in the L edge computing nodes based on attribute information of each edge server included in the L edge computing nodes includes: determining an edge server with the server type group being the ordinary group in the edge servers included in the L edge computing nodes as a candidate edge server.

S3: Determine N edge servers from at least one candidate edge server according to an idle computing power resource of each edge server in the at least one candidate edge server and the first computing power resource.

After some candidate edge servers are obtained through Operation S2, N edge servers are selected from at least one candidate edge server. In some embodiments, an idle computing power resource of each candidate edge server may be compared with the first computing power resource. Edge servers with idle computing power resources greater than the first computing power resource are determined as N edge servers.

In some embodiments, an edge server with an idle computing power resource greater than the first computing power resource in each candidate edge server and a plurality of edge servers with a sum of idle computing power resources greater than the first computing power resource are used as N edge servers. In some embodiments, at least one candidate edge server includes an edge server 1, an edge server 2, and an edge server 3. An idle computing power resource of the edge server 1 is greater than the first computing power resource, an idle computing power resource of the edge server 2 and an idle computing power resource of the edge server 3 are not greater than the first computing power resource. However, a sum of the idle computing power resource of the edge server 2 and the idle computing power resource of the edge server 3 is greater than the first computing power resource. The edge server 1, the edge server 2 and the edge server 3 are used as N edge servers configured to execute the offline task.

In some embodiments, in a case that there is no edge server with an idle computing power resource greater than the first computing power resource in each candidate edge server, a plurality of edge servers with a sum of idle computing power resources greater than the first computing power resource are used as N edge servers.

It is to be illustrated that the first computing power resource may include at least one of the CPU computing power resource or the GPU computing power resource, and the idle computing power resource of each edge server includes any one or more of the CPU computing power resource, the GPU computing power resource, the network bandwidth, the throughput, and the internal memory. The comparison of the computing power resources, or the addition and averaging operations of the computing power resources are performed on the same type of computing power resources. In some embodiments, the first computing power resource includes the GPU computing power resource, and the GPU computing power resource includes a half-precision FLOPS of the GPU, a single-precision FLOPS of the GPU, and a double-precision FLOPS of the GPU. The idle computing power resource of any edge server includes the GPU computing power resource, and the GPU computing power resource also includes a half-precision FLOPS of the GPU, a single-precision FLOPS of the GPU, and a double-precision FLOPS of the GPU. In comparison of the idle computing power resource of any edge server and the first computing power resource, a size relationship between the half-precision FLOPSs of two GPUs, a size relationship between the single-precision FLOPSs of two GPUs, and a size relationship between a double-precision FLOPSs of two GPUs are compared specifically.

Operation S203: Schedule the offline task to N edge servers in a distributed mode, so that each edge server in the N edge servers executes the offline task by using the idle computing power resource of each edge server while ensuring normal operation of the cloud applications.

In some embodiments, the scheduling the offline task to the N edge servers in a distributed mode may include: dividing the offline task into N subtasks based on the idle computing power resource of each edge server in the N edge servers, each subtask in the N subtasks matching an edge server; an idle computing power resource of the edge server matching the each subtask being greater than a computing power resource required to execute the each subtask; and respectively allocating the each subtask to the edge server matching the each subtask, so that each edge server executes the matching subtask.

In some embodiments, in response to an idle computing power resource of each edge server in N edge servers being greater than the first computing power resource, the dividing the offline task into N subtasks based on the idle computing power resource of each edge server includes: evenly dividing the offline task into N subtasks, a computing power resource required to execute each subtask being equal to the first computing power resource/N, in some embodiments, the first computing power resource is x, and the offline task is evenly divided into 5 subtasks, then the computing power resource required to execute each subtask is equal to x/5; and scheduling the N subtasks to the N edge servers, respectively. In this case, each subtask matching an edge server refers to a subtask matching any edge server.

In some embodiments, in a case that there is no edge server with the idle computing power resource greater than the first computing power resource in N edge servers, and a sum of the idle computing power resources of the N edge servers is greater than the first computing power resource, dividing the offline task into N subtasks based on the idle computing power resource of each edge server includes: allocating a subtask to each edge server. A computing power resource required to execute the subtask is less than the idle computing power resource of each edge server, and in this case, a subtask corresponds to a fixed edge server. In some embodiments, N edge servers include an edge server 1, an edge server 2, and an edge server 3. An idle computing power resource of the edge server 1 is equal to x1, an idle computing power resource of the edge server 2 is equal to x2, and an idle computing power resource of the edge server 3 is equal to x3. The offline task is divided into 3 subtasks. A subtask 1 matches the edge server 1, and a computing power resource required to execute the subtask 1 is less than or equal to x1. A subtask 2 matches the edge server 2, and a computing power resource required to execute the subtask 2 is less than or equal to x2. A subtask 3 matches the edge server 3, and a computing power resource required to execute the subtask 3 is less than or equal to x3.

In some embodiments, in response to N edge servers including some edge servers with idle computing power resources greater than the first computing power resource, and also including some edge servers with idle computing power resources not greater than the first computing power resource, dividing the offline task into N subtasks based on the idle computing power resource of each edge server in the N edge servers may include: first dividing, according to an idle computing power resource of each edge server in some edge servers with the idle computing power resources not greater than the first computing power resource, the offline task into a plurality of subtasks matching each edge server in some edge servers; and then evenly dividing the remaining offline tasks and allocating to the edge servers with the idle computing power resources greater than the first computing power resource.

The above are only several implementations of scheduling N edge servers in a distributed mode to execute the offline task listed in some embodiments. However, in some embodiments, other ways of scheduling N edge servers in a distributed mode to execute the offline task may be selected according to specific needs, which is not specifically limited in herein.

In some embodiments, in a process of each edge server executing the matching subtask, the management server may monitor execution of the matching subtask by each edge server. In response to detecting an exception in the execution of a matching subtask by any edge server in the N edge servers, an edge server is reselected to execute a subtask matching the any edge server. In some embodiments, the management server monitors the execution of the matching subtask by each edge server based on a task execution state reported by each edge server, detecting an exception in the execution of a matching subtask by any edge server in the N edge servers may include: the task execution state reported by any edge server to the management server indicates an exception in the execution of a subtask by any edge server. In some embodiments, the management server has not received the task execution state reported by any edge server for a long time.

As can be seen from the above, the offline task corresponds to an execution duration threshold, and N edge servers need to complete the offline task within the execution duration threshold. Because the offline task is divided into N subtasks, then each subtask also corresponds to an execution duration threshold, and the execution duration threshold of each subtask may be equal to the execution duration threshold corresponding to the offline task. During the execution of a matching subtask by each edge server, in a case that any edge server finds that it cannot complete the subtask within the execution duration threshold corresponding to the subtask, any edge server needs to report timeout prompt information to the management server. The timeout prompt information is used for instructing the management server to reallocate a new edge server to execute a subtask matching the edge server that reports the timeout prompt information.

In some embodiments, in a case of receiving an offline task to be executed, a first computing power resource required to execute the offline task may be evaluated, and furthermore N edge servers configured to execute the offline task are obtained, idle computing power resources of the N edge servers are greater than the first computing power resource required to execute the offline task, and the idle computing power resources of the N edge servers refer to a sum of idle computing power resources of edge servers. The offline task is scheduled to the N edge servers in a distributed mode, so that each edge server in the N edge servers executes the offline task by using the idle computing power resource of the each edge server while ensuring normal operation of the cloud applications. In this way, the offline task may also be executed by using the idle computing power resource in each edge server while ensuring normal operation of the cloud applications during peak or off-peak hours of the cloud applications, which avoids the waste of computing power resources in each edge server, improves the utilization of computing power resources, and thus reduces the operating costs of the edge server. In addition, the value of N may be 1 or greater than 1. In a case that the value of N is 1, the centralized execution of the offline task may be ensured, facilitating the execution and management of the offline task. In a case that the value of N is greater than 1, the distributed execution of the offline task is realized. The distributed distribution can not only ensure the execution progress of the offline task, but also share the load of each edge server, so as to ensure the normal operation of cloud applications in each edge server.

FIG. 3 is a schematic flowchart of another service processing method according to some embodiments. The service processing method as shown in FIG. 3 may be executed by an edge server in N edge servers, specifically by a processor of the edge server. The edge server may be any of N edge servers, and cloud applications run on the N edge servers. The service processing method as shown in FIG. 3 may include the following operations:

Operation S301: Receive a distributed offline task scheduled by a management server in a distributed mode.

The distributed offline task may be an offline task received by the management server, or any subtask in N subtasks divided from the offline task. The idle computing power resource of the edge server is greater than a computing power resource required to execute the distributed offline task.

The N subtasks are obtained by performing division processing on the offline task based on an idle computing power resource of each edge server in the N edge servers executing the offline task. The details may be described in operation S203 in the embodiment of FIG. 2, and details are not repeated here.

In some embodiments, before receiving the distributed offline task scheduled by the management server in a distributed mode, the edge server may collect statistics about the idle computing power resource of the edge server and report the idle computing power resource of the edge server to the management server. The idle computing power resource of the edge server may be determined based on a total computing power resource of the edge server and a second computing power resource required to run the cloud application.

In some embodiments, a subtraction operation may be performed on the total computing power resource of the edge server and the second computing power resource, and a result of the subtraction operation may be used as the idle computing power resource of the edge server. That is, the idle computing power resource of the edge server may refer to the remaining computing power resources in the edge server other than the second computing power resource running the cloud application.

In some embodiments, some reserved computing power resources may be set, the reserved computing power resources and the second computing power resource required to run the cloud application are subtracted from the total computing power resource of the edge server, and the remaining computing power resources are the idle computing power resources of the edge server. In this way, in response to a sudden increase in the computing power resources required to run the cloud application, the cloud application may be run by using some of the reserved computing power resources, without interrupting the execution of the distributed offline task.

In practical applications, different cloud applications and different scenarios of a same cloud application have different requirements for computing power resources. In a case of calculating the second computing power resource required to run the cloud application, the computing power resources required for different scenarios of each cloud application may be calculated, and then a minimum computing power resource required for different scenarios is used as the second computing power resource required by the edge server to run the cloud application. In some embodiments, a maximum computing power resource required for different scenarios may also be used as the second computing power resource required by the edge server to run the cloud application. In some embodiments, an average computing power resource required for different scenarios may also be used as the second computing power resource required by the edge server to run the cloud application. The second computing power resource may include any one or more of the CPU computing power resource, the GPU computing power resource, the internal memory, the network bandwidth, and the throughput. The CPU computing power resource generally includes at least one of the FLOPS of the CPU or the OPS of the CPU, and the GPU computing power resource may include at least one of the FLOPS of the GPU or the OPS of the GPU. Since a single edge server and an edge computing node to which the edge server belongs affect the idle computing power resource, the network bandwidth is determined based on an internal network bandwidth and an external network bandwidth. Specifically, the smaller one of the internal network bandwidth and the external network bandwidth is used as the network bandwidth of the edge server.

Operation S302: Execute the distributed offline task by using the idle computing power resource of the edge server while ensuring normal operation of the cloud applications.

As can be seen from the above, the offline task and each subtask obtained by dividing the offline task correspond to an execution duration threshold, and thus the distributed offline task also corresponds to an execution duration threshold. In some embodiments, the executing the distributed offline task by using the idle computing power resource of the edge server includes: determining a duration required to execute the distributed offline task based on the idle computing power resource of the edge server; and executing the distributed offline task by using the idle computing power resource of the edge server in response to the required duration being less than the execution duration threshold corresponding to the distributed offline task.

In some embodiments, the idle computing power resource in each edge server may refer to the remaining computing power resources in the edge server other than the second computing power resource required to run the cloud application. During the execution of the distributed offline task by the edge server, in response to detecting that the resource required to run the cloud application in the edge server suddenly increases to be greater than the second computing power resource, then in order to ensure the normal operation of the cloud application, the edge server may need to perform a computing power release operation. In some embodiments, a dwell duration of the distributed offline task in the edge server may be obtained. The computing power release operation is performed according to a relationship between the dwell duration and the execution duration threshold corresponding to the distributed offline task.

In a case that the time difference between the dwell duration and the execution duration threshold is greater than a time difference threshold, it is indicated that there is still enough time to execute the distributed offline task. In this case, the computing power release operation may include suspending execution of the distributed offline task, so that in response to the computing power resource required for the cloud application being less than or equal to the second computing power resource, the execution of the distributed offline task may be re-enabled. In a case that the time difference between the dwell duration and the execution duration threshold is less than the time difference threshold, it is indicated that there is not much time left to execute the distributed offline task. In this case, it may not be possible to wait for the edge server to recover enough idle resources before continuing to enable the execution of the distributed offline task, and the execution of the distributed offline task may be terminated, and the management server is notified to reselect an edge server with sufficient idle computing power resource to execute the distributed offline task. Therefore, in a case that the time difference between the dwell duration and the execution duration threshold is less than the time difference threshold, the computing power release operation includes terminating execution of the distributed offline task.

In some embodiments, in response to the computing power release operation referring to suspending execution of the distributed offline task, the edge server may periodically detect the idle computing power resource of the edge server after the computing power release operation is performed. In response to detecting that the idle computing power resource of the edge server is greater than the first computing power resource, the execution of the distributed offline task is enabled. In a case that the idle computing power resource of the edge server is less than the first computing power resource, and a difference between a dwell duration of the distributed offline task in the edge server and the execution duration threshold is less than the time difference threshold, the execution of the distributed offline task is terminated. That is, in a process of periodically detecting the idle computing power resource of the edge server, in a case of finding that the idle computing power resource of the edge server is insufficient to execute the distributed offline task, but there is not much time left before the execution duration threshold, the edge server can only give up continuing the distributed offline task and notify the management server to reschedule a new edge server to execute the distributed offline task.

In some embodiments, the edge server transmits timeout prompt information to the management server in response to predicting that the edge server cannot complete the distributed offline task within the execution duration threshold in a process of executing the distributed offline task, the timeout prompt information being used for indicating that the duration required for the edge server to execute the distributed offline task is greater than the execution duration threshold corresponding to the distributed offline task, and the management server needing to reallocate a new edge server to execute the distributed offline task.

In some embodiments, the edge server receives a distributed offline task scheduled by the management server in a distributed mode. The distributed offline task may be an offline task received by the management server, or a subtask in N subtasks matching the edge server. The N subtasks may be obtained by performing division processing on the offline task based on idle computing power resources of N edge servers for executing the offline task. The distributed offline task is executed by using the idle computing power resource of the edge server while ensuring normal operation of the cloud applications. In this way, the distributed offline task may also be executed by using the idle computing power resource in the edge server while ensuring normal operation of the cloud applications during peak or off-peak hours of the cloud applications, which avoids the waste of computing power resources in the edge server, improves the utilization of computing power resources, and thus reduces the operating costs of the edge server.

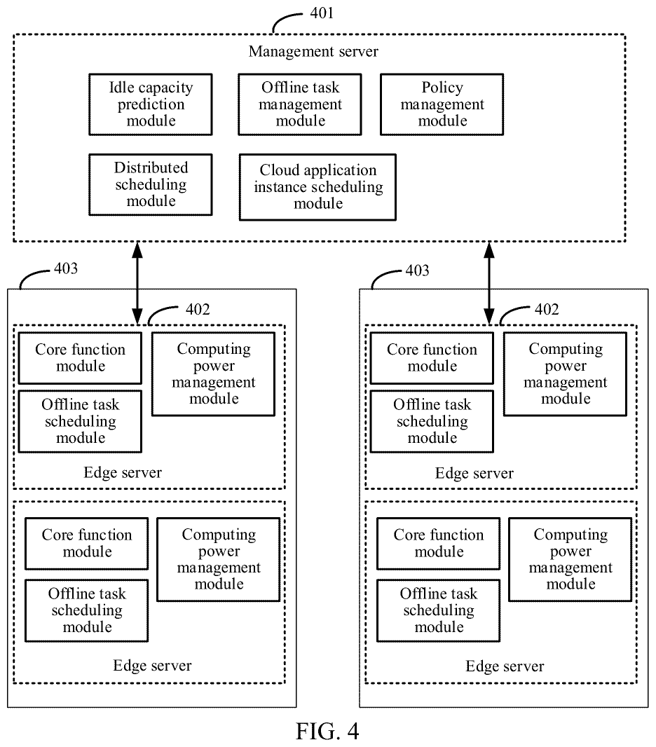

FIG. 4 is a schematic structural diagram of a service processing system according to some embodiments. The service processing system as shown in FIG. 4 may include a management server 401 configured to manage edge computing nodes, and includes at least one edge server 402. The at least one edge server 402 is allocated to P edge computing nodes 403. Each edge computing node 403 includes one or more edge servers.

In some embodiments, each edge server 402 includes a core function module. The core function module is mainly configured to implement a core function of the cloud application. In some embodiments, for cloud gaming, the core function module is configured to game rendering, game logic and other functions. In some embodiments, a computing power resource demand of this module is set to the highest priority. That is, no matter what an offline task an edge is executing, in a case that the module is found to require more computing power resources, then sufficient computing power resources may be allocated to the module first.

In some embodiments, each edge server 402 may also include a computing power management module. The computing power management module is configured to manage the computing power resource of the edge server, ensuring that the demands of all real-time online tasks of a local machine do not exceed the upper limit of a physical computing power. The main functions of the computing power management module may include:
(1) collection and reporting of real-time idle computing power resources of the local machine: data is reported to the management server as the basis for subsequent offline task scheduling; it is to be understood that, in this case, the idle computing power resources of the local machine may be directly reported to the management server 401, or the computing power resources occupied by the local machine and the total computing power resource available may be reported to the management server 401, and the management server 401 collects statistics about the idle computing power resource of the edge server based on the occupied computing power resources and the total computing power resource available; and
(2) computing power management of the local machine: in a case that the computing power required by a real-time online task (some embodiments mainly refer to the cloud application) exceeds the upper limit of the currently available computing power of the local machine, in response to an offline task running, an offline task scheduling module is notified to release the computing power; in a case that there is no offline task or all offline tasks are suspended and the upper limit of the current available computing power of the local machine is exceeded, the management server is notified to schedule some cloud application instances to other edge servers.

In some embodiments, the edge server 402 may further include an offline task scheduling module. The offline task scheduling module is mainly configured to schedule an offline task scheduled by the management server to the local machine in a distributed mode, the main functions may include:
(1) Enable a task. After receiving the offline task issued by the management server (the offline task here may refer to a complete offline task or a subtask obtained by dividing the completed offline task), whether the idle computing power resources of the local machine meet the demands is calculated, mainly to determine whether the idle computing power resources of the local machine may complete the offline task within the execution duration threshold; and if yes, the offline task is enabled. The offline task scheduling module may also periodically check the execution state of the offline task of the local machine. For the offline task that is suspended due to insufficient idle computing power, the current idle computing power resource is rechecked. In a case that the current idle computing power resource is still insufficient, the dwell duration of the offline task on the local machine is checked. In a case that the time difference between the dwell duration and the execution duration threshold is less than the time difference threshold, or the dwell duration exceeds the execution duration threshold, the execution of the offline task is terminated.
(2) Release the computing power. In a case that the computing power management module detects that the computing power required by the current real-time online task is insufficient, the module is notified to release the computing power release operation, which may include suspending the execution of the offline task (for tasks that still have sufficient time to complete, that is, the time difference between the dwell duration of the offline task on the local machine and the execution duration threshold is greater than the time difference threshold), or terminating the execution of the offline task (for tasks that need to be completed immediately, that is, the time difference between the dwell duration of the offline task on the local machine and the execution duration threshold is less than the time difference threshold).
(3) Suspend the offline task. A suspension operation is performed on the offline task according to an instruction of releasing the computing power.
(4) Complete the offline task. In a case that the offline task is executed, temporary data of the local machine is cleaned up, and the completed calculation is reported to the management server.
(5) Terminate the offline task. In a case that the idle computing power resources of the local machine cannot complete the offline task within the execution duration threshold, or an exception occurs, such as the local machine needs to be shut down for maintenance, the offline task is terminated and the offline task is allocated to other edge servers through the management server.

In some embodiments, the management server 401 may include an idle capacity prediction module. The idle capacity prediction module is mainly configured to calculate the idle computing power resource of each edge server and the node idle computing power resource of each edge computing node according to the computing power resource data reported by each edge server.

In some embodiments, the edge server 401 may further include an offline task management module. The main functions of the offline task management module may include:
(1) Task reception. An offline task uploaded by a user is received and classified, the main classification may include whether the offline task has timeliness requirements, whether the main load of the offline task is GPU-type or CPU-type, and whether the offline task may be executed in a distributed mode.
(2) Task allocation. The computing power resource required to execute the offline task is matched with the idle computing power resource of each edge server to allocate the offline task to an appropriate edge server. In a case that a single edge server cannot complete the offline task alone, the offline task is distributed to a distributed scheduling module for allocation.
(3) Task process management. The task execution state reported by the edge server that executes the cloud application is received, and in response to determining that the offline task is executed according to the task execution state, an execution result is verified and fed back to the user. In response to determining an exception in the execution of the offline task according to the task execution state, or in a case that the task execution state reported by the edge server has not been received for a long time, the offline task is rescheduled to a new edge server.

In some embodiments, the management server 401 further includes a policy management module. The main functions of the policy management module may include:
(1) Whitelist management. For some edge servers that need to run high-priority and uninterrupted cloud applications, these edge servers need to be added to a default whitelist to ensure that these edge servers are not scheduled for the offline task. At the same time, these edge servers do not need to be in the default whitelist all the time, and these edge servers are removed from the default whitelist after the high-priority cloud application ends.
(2) Edge server state management. The working state of the edge server includes a busy state and an idle state. In a case that an edge server reports that the current edge server exceeds the upper limit of the load, the working state of the edge server is set as the busy state, to avoid allocating a new offline task and cloud application instances to the edge server. In a case that the edge server informs the management server of the current idle state, the working state of the edge server is modified to the idle state, and the idle computing power resources of the edge server may be recalculated.

In some embodiments, the management server 401 may further include a distributed scheduling module. The main functions of the distributed scheduling module may include:
(1) Task scheduling. A large offline task is divided into a plurality of subtasks according to an idle computing power resource of each edge server configured to execute the offline task, and each subtask is allocated to an edge server for execution. In a case that each edge server completes the execution of a corresponding subtask, an execution result is reported to the management server 401, and the management server summarizes the reported execution result to obtain a final execution result.
(2) Abnormal edge server management. In a case that an exception occurs in a certain edge server such as abnormal, disconnected, or computed timeout due to real-time computing, it promptly discovers and schedules offline tasks to other edge servers for execution.

In some embodiments, the management server 401 may further include a cloud application instance scheduling module, configured to dynamically allocate instances of the cloud application according to the computing power resource of each edge server and the node computing power resource of each edge computing node, avoiding overload of a single edge server.

In the service processing system, in a case that the management server receives an offline task to be executed, a first computing power resource required to execute the offline task may be evaluated, and furthermore N edge servers configured to execute the offline task are obtained, idle computing power resources of the N edge servers are greater than the first computing power resource required to execute the offline task, and the idle computing power resources of the N edge servers refer to a sum of idle computing power resources of edge servers. The offline task is scheduled to the N edge servers in a distributed mode.

After any edge server in the N edge servers receives the offline task scheduled by the management server in a distributed mode, the offline task is executed by using the idle computing power resource of the edge server while ensuring normal operation of the cloud applications. In this way, the distributed offline task may also be executed by using the idle computing power resource in the edge server while ensuring normal operation of the cloud applications during peak or off-peak hours of the cloud applications, which avoids the waste of computing power resources in the edge server, improves the utilization of computing power resources, and thus reduces the operating costs of the edge server.

In addition, the value of N may be 1 or greater than 1. In a case that the value of N is 1, the centralized execution of the offline task may be ensured, facilitating the execution and management of the offline task. In a case that the value of N is greater than 1, the distributed execution of the offline task is realized. The distributed distribution can not only ensure the execution progress of the offline task, but also share the load of each edge server, so as to ensure the normal operation of cloud applications in each edge server.

It is to be understood that, although the operations are displayed sequentially according to the instructions of the arrows in the flowcharts of the embodiments, these operations are not necessarily performed sequentially according to the sequence instructed by the arrows. Unless otherwise explicitly specified in this application, execution of the operations is not strictly limited, and the operations may be performed in other sequences. Moreover, at least some of the operations in each embodiment may include a plurality of operations or a plurality of stages. The operations or stages are not necessarily performed at the same moment but may be performed at different moments. Execution of the operations or stages is not necessarily sequentially performed, but may be performed alternately with other operations or at least some of operations or stages of other operations.

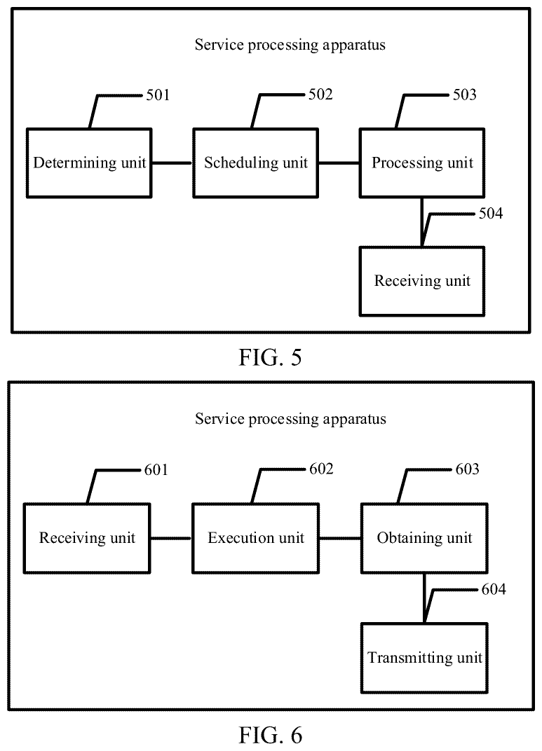

FIG. 5 is a schematic structural diagram of a service processing apparatus according to some embodiments. The service processing apparatus as shown in FIG. 5 may run the following units:
a determining unit 501, configured to determine a first computing power resource required to execute an offline task;
the determining unit 501 being further configured to determine N edge servers configured to execute the offline task, cloud applications running on the N edge servers; idle computing power resources of the N edge servers being greater than the first computing power resource, the idle computing power resources of the N edge servers referring to a sum of idle computing power resources of edge servers in the N edge servers, and N being an integer greater than or equal to 1; and
a scheduling unit 502, configured to schedule the offline task to the N edge servers in a distributed mode, so that each edge server in the N edge servers executes the offline task by using the idle computing power resource of the each edge server while ensuring normal operation of the cloud applications.

In some embodiments, in a case that the scheduling unit 502 schedules the offline task to the N edge servers in a distributed mode, the following operations are executed:
dividing the offline task into N subtasks based on the idle computing power resource of each edge server in the N edge servers, each subtask in the N subtasks matching an edge server;
an idle computing power resource of the edge server matching the each subtask being greater than a computing power resource required to execute the each subtask; and respectively allocating the each subtask to the edge server matching the each subtask, so that each edge server executes the matching subtask.

In some embodiments, the cloud applications are deployed to M edge servers for execution, the M edge servers are allocated to P edge computing nodes, and each edge computing node is deployed with one or more edge servers, M and P being integers greater than or equal to 1. In a case of determining N edge servers configured to execute the offline task, the determining unit 501 executes the following operations:
selecting L edge computing nodes from the P edge computing nodes, node idle computing power resources of the L edge computing nodes being greater than the first computing power resource, and the node idle computing power resources of the L edge computing nodes referring to a sum of node idle computing power resources of edge computing nodes; the node idle computing power resource of each edge computing node being obtained according to idle computing power resources of edge servers deployed in the each edge computing node;
determining at least one candidate edge server from edge servers included in the L edge computing nodes based on attribute information of each edge server included in the L edge computing nodes; and determining N edge servers from the at least one candidate edge server according to an idle computing power resource of each edge server in the at least one candidate edge server and the first computing power resource.

In some embodiments, the attribute information of the each edge server includes a working state of each edge server, and the working state includes an idle state or a busy state. In a case of determining at least one candidate edge server from edge servers included in the L edge computing nodes, the determining unit 501 executes the following operations:
determining an edge server with the working state being the idle state in the edge servers included in the L edge computing nodes as a candidate edge server.

In some embodiments, the attribute information of the each edge server includes a server type group to which each edge server belongs, and the server type group includes a default whitelist group and an ordinary group. In a case of determining at least one candidate edge server from edge servers included in the L edge computing nodes based on the attribute information of each edge server included in the L edge computing nodes, the determining unit 501 executes the following operations:
determining an edge server with the server type group being the ordinary group in the edge servers included in the L edge computing nodes as a candidate edge server.

In some embodiments, the service processing apparatus further includes a processing unit 503, configured to: monitor execution of the matching subtask by each edge server in a process of each edge server executing the matching subtask; and reselect, in response to monitoring an exception in the execution of the matching subtask by any edge server in the N edge servers, an edge server to execute a subtask matching the any edge server.

In some embodiments, a subtask corresponds to an execution duration threshold. The service processing apparatus further includes a receiving unit 504, configured to receive timeout prompt information reported by any edge server in the process of each edge server executing the matching subtask. The timeout prompt information is used for indicating that a duration required for the any edge server to execute the matching subtask is greater than the execution duration threshold corresponding to the matching subtask, and a new edge server needs to be reallocated to execute the matching subtask of the any edge server.

In some embodiments, the first computing power resource includes any one or more of the following: a GPU computing power resource, a CPU computing power resource, an internal memory, a network bandwidth, and a network throughput. The GPU computing power resource includes at least one of the following: a FLOPS of the GPU and an OPS of the GPU. The CPU computing power resource includes at least one of the following: a FLOPS of the CPU and an OPS of the CPU.

In some embodiments, in a case of determining a first computing power resource required to execute an offline task, the determining unit executes the following operations:
determining a computation complexity corresponding to a task type of the offline task based on a correspondence between the task type and the computation complexity; finding at least one matching historical offline task from historical offline tasks according to the determined computation complexity, a computation complexity corresponding to each matching historical offline task matching the determined computation complexity; and estimating a computing power resource required for the offline task based on a computing power resource used for executing each matching historical offline task, to obtain a first computing power resource required to execute the offline task.

According to some embodiments, operations involved in the service processing method as shown in FIG. 2 may be executed by units in the service processing apparatus as shown in FIG. 5. In some embodiments, operations S201 and S202 in FIG. 2 may be executed by the determining unit 501 in the service processing apparatus as shown in FIG. 5, and operation S203 may be executed by the scheduling unit 502 in the service processing apparatus as shown in FIG. 5.

According to some embodiments of the present disclosure, the units in the service processing apparatus as shown in FIG. 5 may be respectively or wholly integrated into one additional unit or a plurality of additional units. In some embodiments, a unit (or some units) in the service processing apparatus may be further split into a plurality of units having smaller functions. This may implement same operations without affecting implementation of the technical effects of this embodiment of the present disclosure. The foregoing units are divided based on logical functions. In an actual application, the function of a unit may be implemented by a plurality of units, or functions of a plurality of units are implemented by a unit. In some embodiments of the present disclosure, the service processing apparatus may also include another unit. In practical applications, these functions may also be cooperatively implemented by another unit and may be cooperatively implemented by a plurality of units.

According to some embodiments of the present disclosure, a computer-readable instruction (including a program code) that can perform each operation in the corresponding method as shown in FIG. 2 may be run on a general-purpose computing device, in some embodiments, a computer, that includes a processing element and a storage element such as a CPU, a random access memory (RAM), and a read-only memory (ROM), to construct the service processing apparatus as shown in FIG. 5, and to implement the service processing method according to the embodiment of the present disclosure. The computer-readable instruction may be recorded in, in some embodiments, a computer storage medium, and may be loaded into the node device by using the computer storage medium, and run in the node device.

In some embodiments, in a case of receiving an offline task to be executed, a first computing power resource required to execute the offline task may be evaluated, and furthermore N edge servers configured to execute the offline task are obtained, idle computing power resources of the N edge servers are greater than the first computing power resource required to execute the offline task, and the idle computing power resources of the N edge servers refer to a sum of idle computing power resources of edge servers. The offline task is scheduled to the N edge servers in a distributed mode, so that each edge server in the N edge servers executes the offline task by using the idle computing power resource of the each edge server while ensuring normal operation of the cloud applications. In this way, the offline task may also be executed by using the idle computing power resource in each edge server while ensuring normal operation of the cloud applications during peak or off-peak hours of the cloud applications, which avoids the waste of computing power resources in each edge server, improves the utilization of computing power resources, and thus reduces the operating costs of the edge server. In addition, the value of N may be 1 or greater than 1. In a case that the value of N is 1, the centralized execution of the offline task may be ensured, facilitating the execution and management of the offline task. In a case that the value of N is greater than 1, the distributed execution of the offline task is realized. The distributed distribution can not only ensure the execution progress of the offline task, but also share the load of each edge server, so as to ensure the normal operation of cloud applications in each edge server.

FIG. 6 is a schematic structural diagram of another service processing apparatus according to some embodiments. The service processing apparatus as shown in FIG. 6 may run the following units:
a receiving unit 601, configured to receive a distributed offline task scheduled by a management server in a distributed mode, the distributed offline task including an offline task received by the management server, or the distributed offline task including a subtask in N subtasks matching the edge server, and the N subtasks being obtained by performing division processing on the offline task based on an idle computing power resource of each edge server in the N edge server; and the N edge servers being configured to execute the offline task, and cloud applications running on the N edge servers; and
an execution unit 602, configured to execute the distributed offline task by using the idle computing power resource of the edge server while ensuring normal operation of a target cloud application.

In some embodiments, the distributed offline task corresponds to an execution duration threshold. In a case of executing the distributed offline task by using the idle computing power resource of the edge server, the execution unit 602 executes the following operations:
determining a duration required to execute the distributed offline task based on the idle computing power resource of the edge server; and executing the distributed offline task by using the idle computing power resource of the edge server in response to the required duration being less than the execution duration threshold corresponding to the distributed offline task.

In some embodiments, the idle computing power resource of the edge server refers to the remaining computing power resources of the edge server other than a second computing power resource required to run the cloud applications. The service processing apparatus further includes an obtaining unit 603.

The obtaining unit 603 is configured to obtain a dwell duration of the distributed offline task in the edge server in response to monitoring that a resource required to run the cloud application in the edge server is greater than the second computing power resource in a process of executing the distributed offline task.

The execution unit 602 is configured to execute a computing power release operation according to a relationship between the dwell duration and the execution duration threshold. The computing power release operation includes suspending execution of the distributed offline task or terminating the execution of the distributed offline task. The computing power release operation includes suspending execution of the distributed offline task in a case that a time difference between the dwell duration and the execution duration threshold is greater than a time difference threshold. The computing power release operation includes terminating execution of the distributed offline task in a case that the time difference between the dwell duration and the execution duration threshold is less than the time difference threshold.

In some embodiments, in a case that the computing power release operation includes suspending execution of the distributed offline task, the execution unit 602 is further configured to: periodically detect an idle computing power resource of the edge server; enable the execution of the distributed offline task in a case that the idle computing power resource of the edge server is greater than the first computing power resource; and terminate the execution of the distributed offline task in a case that the idle computing power resource of the edge server is less than the first computing power resource, and a difference between a dwell duration of the distributed offline task in the edge server and the execution duration threshold is less than the time difference threshold.

In some embodiments, the service processing apparatus further includes a transmitting unit 604, configured to transmit timeout prompt information to the management server in response to predicting that a duration required for the edge server to execute the distributed offline task is greater than the execution duration threshold in a process of the edge server executing the distributed offline task, the timeout prompt information being used for indicating that the duration required for the edge server to execute the distributed offline task is greater than the execution duration threshold, and the management server needing to reallocate a new edge server to execute the distributed offline task.

According to some embodiments, operations involved in the service processing method as shown in FIG. 3 may be executed by units in the service processing apparatus as shown in FIG. 6. In some embodiments, operation S301 in FIG. 3 may be executed by the receiving unit 601 in the service processing apparatus as shown in FIG. 6, and operation S302 may be executed by the execution unit 602 in the service processing apparatus as shown in FIG. 6.

A person skilled in the art would understand that the above described “units” could be implemented by hardware logic, a processor or processors executing computer software code, or a combination of both. The “units” may also be implemented in software stored in a memory of a computer or a non-transitory computer-readable medium, where the instructions of each module and unit are executable by a processor to thereby cause the processor to perform the respective operations of the corresponding unit.

According to some embodiments, each unit, or code, in the apparatus may exist respectively or be combined into one or more units. Certain (or some) unit in the units may be further split into multiple smaller function subunits, thereby implementing the same operations without affecting the technical effects of some embodiments. In some embodiments, the apparatus may further include other units. In actual applications, these functions may also be realized cooperatively by the other units, and may be realized cooperatively by multiple units

According to some embodiments of the present disclosure, the units in the service processing apparatus as shown in FIG. 6 may be respectively or wholly integrated into one additional unit or a plurality of additional units. In some embodiments, a unit (or some units) in the service processing apparatus may be further split into a plurality of units having smaller functions. This may implement same operations without affecting implementation of the technical effects of this embodiment of the present disclosure. The foregoing units are divided based on logical functions. In an actual application, the function of a unit may be implemented by a plurality of units, or functions of a plurality of units are implemented by a unit. In some embodiments of the present disclosure, the service processing apparatus may also include another unit. In practical applications, these functions may also be cooperatively implemented by another unit and may be cooperatively implemented by a plurality of units.

According to some embodiments of the present disclosure, a computer-readable instruction (including a program code) that can perform each operation in the corresponding method as shown in FIG. 3 may be run on a general-purpose computing device, in some embodiments, a computer, that includes a processing element and a storage element such as a CPU, a random access memory (RAM), and a read-only memory (ROM), to construct the service processing apparatus as shown in FIG. 6, and to implement the service processing method according to the embodiment of the present disclosure. The computer-readable instruction may be recorded in, in some embodiments, a computer storage medium, and may be loaded into the node device by using the computer storage medium, and run in the node device.

In some embodiments, the edge server receives a distributed offline task scheduled by the management server in a distributed mode. The distributed offline task may be an offline task received by the management server, or a subtask in N subtasks matching the edge server. The N subtasks may be obtained by performing division processing on the offline task based on idle computing power resources of N edge servers for executing the offline task. The distributed offline task is executed by using the idle computing power resource of the edge server while ensuring normal operation of the cloud applications. In this way, the distributed offline task may also be executed by using the idle computing power resource in the edge server while ensuring normal operation of the cloud applications during peak or off-peak hours of the cloud applications, which avoids the waste of computing power resources in the edge server, improves the utilization of computing power resources, and thus reduces the operating costs of the edge server.

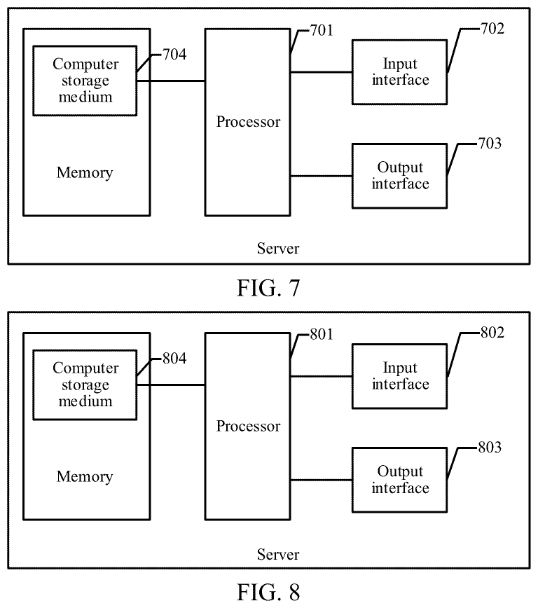

FIG. 7 is a schematic structural diagram of a server according to some embodiments. The server as shown in FIG. 7 may correspond to the management server. The server as shown in FIG. 7 may include a processor 701, an input interface 702, an output interface 703, and a computer storage medium 704. The processor 701, the input interface 702, the output interface 703, and the computer storage medium 704 may be connected via a bus or in another manner.

The computer storage medium 704 may be stored in a memory of the server. The computer storage medium 704 is configured to store computer-readable instructions, and the processor 701 is configured to execute the computer-readable instructions stored by the computer storage medium 704. The processor 701 (or referred to as a central processing unit (CPU)) is a computing core and a control core of the server, and is suitable to implement one or more computer-readable instructions, specifically to load and execute:
determining a first computing power resource required to execute an offline task; determining N edge servers configured to execute the offline task, cloud applications running on the N edge servers; idle computing power resources of the N edge servers being greater than the first computing power resource, the idle computing power resources of the N edge servers referring to a sum of idle computing power resources of edge servers in the N edge servers, and N being an integer greater than or equal to 1; and scheduling the offline task to the N edge servers in a distributed mode, so that each edge server in the N edge servers executes the offline task by using the idle computing power resource of the each edge server while ensuring normal operation of the cloud applications.

In some embodiments, in a case of receiving an offline task to be executed, a first computing power resource required to execute the offline task may be evaluated, and furthermore N edge servers configured to execute the offline task are obtained, idle computing power resources of the N edge servers are greater than the first computing power resource required to execute the offline task, and the idle computing power resources of the N edge servers refer to a sum of idle computing power resources of edge servers. The offline task is scheduled to the N edge servers in a distributed mode, so that each edge server in the N edge servers executes the offline task by using the idle computing power resource of the each edge server while ensuring normal operation of the cloud applications. In this way, the offline task may also be executed by using the idle computing power resource in each edge server while ensuring normal operation of the cloud applications during peak or off-peak hours of the cloud applications, which avoids the waste of computing power resources in each edge server, improves the utilization of computing power resources, and thus reduces the operating costs of the edge server. In addition, the value of N may be 1 or greater than 1. In a case that the value of N is 1, the centralized execution of the offline task may be ensured, facilitating the execution and management of the offline task. In a case that the value of N is greater than 1, the distributed execution of the offline task is realized. The distributed distribution can not only ensure the execution progress of the offline task, but also share the load of each edge server, so as to ensure the normal operation of cloud applications in each edge server.

FIG. 8 is a schematic structural diagram of another server according to some embodiments. The server as shown in FIG. 8 may correspond to the edge server. The server as shown in FIG. 8 may include a processor 801, an input interface 802, an output interface 803, and a computer storage medium 804. The processor 801, the input interface 802, the output interface 803, and the computer storage medium 804 may be connected via a bus or in another manner.

The computer storage medium 804 may be stored in a memory of the terminal. The computer storage medium 804 is configured to store computer-readable instructions, and the processor 801 is configured to execute the computer-readable instructions stored by the computer storage medium 804. The processor 801 (or referred to as a central processing unit (CPU)) is a computing core and a control core of the terminal, and is suitable to implement one or more computer-readable instructions, specifically to load and execute:
receiving a distributed offline task scheduled by a management server in a distributed mode, the distributed offline task including the offline task received by the management server; or the distributed offline task including a subtask in N subtasks matching the edge server, and the N subtasks being obtained by performing division processing on the offline task based on an idle computing power resource of each edge server in the N edge server; and
executing the distributed offline task by using the idle computing power resource of the edge server while ensuring normal operation of the cloud applications.

In some embodiments, the edge server receives a distributed offline task scheduled by the management server in a distributed mode. The distributed offline task may be an offline task received by the management server, or a subtask in N subtasks matching the edge server. The N subtasks may be obtained by performing division processing on the offline task based on idle computing power resources of N edge servers for executing the offline task. The distributed offline task is executed by using the idle computing power resource of the edge server while ensuring normal operation of the cloud applications. In this way, the distributed offline task may also be executed by using the idle computing power resource in the edge server while ensuring normal operation of the cloud applications during peak or off-peak hours of the cloud applications, which avoids the waste of computing power resources in the edge server, improves the utilization of computing power resources, and thus reduces the operating costs of the edge server.

Some embodiments of the present disclosure also provides a computer storage medium (memory). The computer storage medium is a memory device of the server for storing programs and data. It is to be understood that the computer storage medium here may include an internal storage medium of the server, and may also include an expanded storage medium supported by the server. The computer storage medium provides a storage space that stores an operating system of the server. Moreover, the storage space also stores computer-readable instructions suitable for being loaded and executed by the processor 801 or the processor 901. It is to be illustrated that the computer storage medium here may be a high-speed RAM memory, or a non-volatile memory, in some embodiments, at least one magnetic disk memory. In some embodiments, the computer storage medium may also be at least one computer storage medium away from the processor.

In some embodiments, the computer-readable instructions stored in the computer storage medium may be loaded and executed by the processor 801:
determining a first computing power resource required to execute an offline task; determining N edge servers configured to execute the offline task, cloud applications running on the N edge servers; idle computing power resources of the N edge servers being greater than the first computing power resource, the idle computing power resources of the N edge servers referring to a sum of idle computing power resources of edge servers in the N edge servers, and N being an integer greater than or equal to 1; and scheduling the offline task to the N edge servers in a distributed mode, so that each edge server in the N edge servers executes the offline task by using the idle computing power resource of the each edge server while ensuring normal operation of the cloud applications.

In some embodiments, in a case of scheduling the offline task to the N edge servers in a distributed mode, the processor 801 executes the following operations:
dividing the offline task into N subtasks based on the idle computing power resource of each edge server in the N edge servers, each subtask in the N subtasks matching an edge server; an idle computing power resource of the edge server matching the each subtask being greater than a computing power resource required to execute the each subtask; and respectively allocating the each subtask to the edge server matching the each subtask, so that each edge server executes the matching subtask.

In some embodiments, the cloud applications are deployed to M edge servers for execution, the M edge servers are allocated to P edge computing nodes, and each edge computing node is deployed with one or more edge servers, M and P being integers greater than or equal to 1. In a case of determining N edge servers configured to execute the offline task, the processor 801 executes the following operations:
selecting L edge computing nodes from the P edge computing nodes, node idle computing power resources of the L edge computing nodes being greater than the first computing power resource, and the node idle computing power resources of the L edge computing nodes referring to a sum of node idle computing power resources of edge computing nodes; the node idle computing power resource of each edge computing node being obtained according to idle computing power resources of edge servers deployed in the each edge computing node;
determining at least one candidate edge server from edge servers included in the L edge computing nodes based on attribute information of each edge server included in the L edge computing nodes; and
determining N edge servers from the at least one candidate edge server according to an idle computing power resource of each edge server in the at least one candidate edge server and the first computing power resource.

In some embodiments, the attribute information of the each edge server includes a working state of each edge server, and the working state includes an idle state or a busy state. In a case of determining at least one candidate edge server from edge servers included in the L edge computing nodes based on the attribute information of each edge server included in the L edge computing nodes, the processor 801 executes the following operation: determining an edge server with the working state being the idle state in the edge servers included in the L edge computing nodes as a candidate edge server.

In some embodiments, the attribute information of the each edge server includes a server type group to which each edge server belongs, and the server type group includes a default whitelist group and an ordinary group. In a case of determining at least one candidate edge server from edge servers included in the L edge computing nodes based on the attribute information of each edge server included in the L edge computing nodes, the processor 801 executes the following operations: determining an edge server with the server type group being the ordinary group in the edge servers included in the L edge computing nodes as a candidate edge server.

In some embodiments, the processor 801 is further configured to: monitor execution of the matching subtask by each edge server in a process of each edge server executing the matching subtask; and reselect, in response to monitoring an exception in the execution of the matching subtask by any edge server in the N edge servers, an edge server to execute a subtask matching the any edge server.

In some embodiments, a subtask corresponds to an execution duration threshold. The processor 801 is further configured to: receive timeout prompt information reported by any edge server in the process of each edge server executing the matching subtask, the timeout prompt information being used for indicating that a duration required for the any edge server to execute the matching subtask is greater than the execution duration threshold corresponding to the matching subtask, and a new edge server needs to be reallocated to execute the matching subtask of the any edge server.

In some embodiments, the first computing power resource includes any one or more of the following: a GPU computing power resource, a CPU computing power resource, an internal memory, a network bandwidth, and a network throughput. The GPU computing power resource includes at least one of the following: a FLOPS of the GPU and an OPS of the GPU. The CPU computing power resource includes at least one of the following: a FLOPS of the CPU and an OPS of the CPU.

In some embodiments, in a case of determining a first computing power resource required to execute an offline task, the processor 801 executes the following operations: determining a computation complexity corresponding to a task type of the offline task based on a correspondence between the task type and the computation complexity; finding at least one matching historical offline task from historical offline tasks according to the determined computation complexity, a computation complexity corresponding to each matching historical offline task matching the determined computation complexity; and estimating a computing power resource required for the offline task based on a computing power resource used for executing each matching historical offline task, to obtain a first computing power resource required to execute the offline task.

In some embodiments, in a case of receiving an offline task to be executed, a first computing power resource required to execute the offline task may be evaluated, and furthermore N edge servers configured to execute the offline task are obtained, idle computing power resources of the N edge servers are greater than the first computing power resource required to execute the offline task, and the idle computing power resources of the N edge servers refer to a sum of idle computing power resources of edge servers. The offline task is scheduled to the N edge servers in a distributed mode, so that each edge server in the N edge servers executes the offline task by using the idle computing power resource of the each edge server while ensuring normal operation of the cloud applications. In this way, the offline task may also be executed by using the idle computing power resource in each edge server while ensuring normal operation of the cloud applications during peak or off-peak hours of the cloud applications, which avoids the waste of computing power resources in each edge server, improves the utilization of computing power resources, and thus reduces the operating costs of the edge server. In addition, the value of N may be 1 or greater than 1. In a case that the value of N is 1, the centralized execution of the offline task may be ensured, facilitating the execution and management of the offline task. In a case that the value of N is greater than 1, the distributed execution of the offline task is realized. The distributed distribution can not only ensure the execution progress of the offline task, but also share the load of each edge server, so as to ensure the normal operation of cloud applications in each edge server.

In some embodiments, the computer-readable instructions stored in the computer storage medium may be loaded and executed by the processor 901:
receiving a distributed offline task scheduled by a management server in a distributed mode, the distributed offline task including the offline task received by the management server; or the distributed offline task including a subtask in N subtasks matching the edge server, and the N subtasks being obtained by performing division processing on the offline task based on an idle computing power resource of each edge server in the N edge server; and executing the distributed offline task by using the idle computing power resource of the edge server while ensuring normal operation of the cloud applications.

In some embodiments, the distributed offline task corresponds to an execution duration threshold. In a case of executing the distributed offline task by using the idle computing power resource of the edge server, the processor 901 executes the following operations:
determining a duration required to execute the distributed offline task based on the idle computing power resource of the edge server; and executing the distributed offline task by using the idle computing power resource of the edge server in response to the required duration being less than the execution duration threshold corresponding to the distributed offline task.

In some embodiments, the idle computing power resource of the edge server refers to the remaining computing power resources of the edge server other than a second computing power resource required to run the cloud applications. The processor 901 is further configured to execute:
obtaining a dwell duration of the distributed offline task in the edge server in response to monitoring that a resource required to run the cloud application in the edge server is greater than the second computing power resource in a process of executing the distributed offline task; and
executing a computing power release operation according to a relationship between the dwell duration and the execution duration threshold. The computing power release operation includes suspending execution of the distributed offline task or terminating the execution of the distributed offline task. The computing power release operation includes suspending execution of the distributed offline task in a case that a time difference between the dwell duration and the execution duration threshold is greater than a time difference threshold. The computing power release operation includes terminating execution of the distributed offline task in a case that the time difference between the dwell duration and the execution duration threshold is less than the time difference threshold.

In some embodiments, the computing power release operation includes suspending execution of the distributed offline task. In a case of executing the computing power release operation, the processor 901 is further configured to:
periodically detect an idle computing power resource of the edge server; enable the execution of the distributed offline task in a case that the idle computing power resource of the edge server is greater than the first computing power resource; and terminate the execution of the distributed offline task in a case that the idle computing power resource of the edge server is less than the first computing power resource, and a difference between a dwell duration of the distributed offline task in the edge server and the execution duration threshold is less than the time difference threshold.

In some embodiments, the processor 901 is further configured to: transmit timeout prompt information to the management server in response to predicting that a duration required for the edge server to execute the distributed offline task is greater than the execution duration threshold in a process of the edge server executing the distributed offline task, the timeout prompt information being used for indicating that the duration required for the edge server to execute the distributed offline task is greater than the execution duration threshold, and the management server needing to reallocate a new edge server to execute the distributed offline task.

In some embodiments, the edge server receives a distributed offline task scheduled by the management server in a distributed mode. The distributed offline task may be an offline task received by the management server, or a subtask in N subtasks matching the edge server. The N subtasks may be obtained by performing division processing on the offline task based on idle computing power resources of N edge servers for executing the offline task. The distributed offline task is executed by using the idle computing power resource of the edge server while ensuring normal operation of the cloud applications. In this way, the distributed offline task may also be executed by using the idle computing power resource in the edge server while ensuring normal operation of the cloud applications during peak or off-peak hours of the cloud applications, which avoids the waste of computing power resources in the edge server, improves the utilization of computing power resources, and thus reduces the operating costs of the edge server.

Some embodiments of the present disclosure also provide a computer program product. The computer program product includes a computer-readable instruction stored in a computer storage medium.

In some embodiments, the processor 801 reads the computer-readable instruction from the computer storage medium, so that the server loads and executes: determining a first computing power resource required to execute an offline task; determining N edge servers configured to execute the offline task, cloud applications running on the N edge servers; idle computing power resources of the N edge servers being greater than the first computing power resource, the idle computing power resources of the N edge servers referring to a sum of idle computing power resources of edge servers in the N edge servers, and N being an integer greater than or equal to 1; and scheduling the offline task to the N edge servers in a distributed mode, so that each edge server in the N edge servers executes the offline task by using the idle computing power resource of the each edge server while ensuring normal operation of the cloud applications.

In some embodiments, in a case of receiving an offline task to be executed, a first computing power resource required to execute the offline task may be evaluated, and furthermore N edge servers configured to execute the offline task are obtained, idle computing power resources of the N edge servers are greater than the first computing power resource required to execute the offline task, and the idle computing power resources of the N edge servers refer to a sum of idle computing power resources of edge servers. The offline task is scheduled to the N edge servers in a distributed mode, so that each edge server in the N edge servers executes the offline task by using the idle computing power resource of the each edge server while ensuring normal operation of the cloud applications. In this way, the offline task may also be executed by using the idle computing power resource in each edge server while ensuring normal operation of the cloud applications during peak or off-peak hours of the cloud applications, which avoids the waste of computing power resources in each edge server, improves the utilization of computing power resources, and thus reduces the operating costs of the edge server. In addition, the value of N may be 1 or greater than 1. In a case that the value of N is 1, the centralized execution of the offline task may be ensured, facilitating the execution and management of the offline task. In a case that the value of N is greater than 1, the distributed execution of the offline task is realized. The distributed distribution can not only ensure the execution progress of the offline task, but also share the load of each edge server, so as to ensure the normal operation of cloud applications in each edge server.

In some embodiments, the processor 901 reads the computer-readable instruction from the computer storage medium, and the processor 901 executes the computer-readable instruction, so that the server executes:
receiving a distributed offline task scheduled by a management server in a distributed mode, the distributed offline task including the offline task received by the management server; or the distributed offline task including a subtask in N subtasks matching the edge server, and the N subtasks being obtained by performing division processing on the offline task based on an idle computing power resource of each edge server in the N edge server; and executing the distributed offline task by using the idle computing power resource of the edge server while ensuring normal operation of the cloud applications.

In some embodiments, the edge server receives a distributed offline task scheduled by the management server in a distributed mode. The distributed offline task may be an offline task received by the management server, or a subtask in N subtasks matching the edge server. The N subtasks may be obtained by performing division processing on the offline task based on idle computing power resources of N edge servers for executing the offline task. The distributed offline task is executed by using the idle computing power resource of the edge server while ensuring normal operation of the cloud applications. In this way, the distributed offline task may also be executed by using the idle computing power resource in the edge server while ensuring normal operation of the cloud applications during peak or off-peak hours of the cloud applications, which avoids the waste of computing power resources in the edge server, improves the utilization of computing power resources, and thus reduces the operating costs of the edge server.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and reflected in the appended claims.

What is claimed is:

1. A service processing method, performed by a management server, the service processing method comprising:
determining a first computing power resource for executing an offline task;
determining N edge servers configured to execute the offline task and on which cloud applications are running based on idle computing power resources of the N edge servers being greater than the first computing power resource, N being an integer greater than or equal to 1; and
scheduling the offline task to the N edge servers in a distributed mode while ensuring normal operation of the cloud applications, so that for each edge server in the N edge servers, the edge server executes the offline task using the idle computing power resource of the edge server.

2. The service processing method according to claim 1, wherein the scheduling comprises:
dividing the offline task into N subtasks based on the idle computing power resources of the N edge servers; and
respectively allocating the N subtasks to the N edge servers, so that each edge server in the N edge servers executes a corresponding subtask.

3. The service processing method according to claim 1, wherein the cloud applications are deployed to M edge servers for execution, the M edge servers are allocated to P edge computing nodes, and each of the P edge computing nodes is deployed with one or more edge servers, M and P being integers greater than or equal to 1; and
wherein determining the N edge servers comprises:
selecting L edge computing nodes from the P edge computing nodes such that node idle computing power resources of the L edge computing nodes are greater than the first computing power resource, the node idle computing power resource being obtained according to the idle computing power resources of the edge servers deployed in the each edge computing node;
determining at least one candidate edge server from edge servers comprised in the L edge computing nodes based on attribute information of each edge server comprised in the L edge computing nodes; and
determining the N edge servers from the at least one candidate edge server according to the idle computing power resource of each edge server in the at least one candidate edge server and the first computing power resource.

4. The service processing method according to claim 3, wherein the attribute information of the each edge server comprises a working state of each edge server, and the working state comprises an idle state or a busy state; and
wherein determining the at least one candidate edge server comprises:
determining an edge server with the working state being the idle state of the edge servers comprised in the L edge computing nodes as a candidate edge server.

5. The service processing method according to claim 3, wherein the attribute information of the each edge server comprises a server type group to which the each edge server belongs, and the server type group comprises a default whitelist group and an ordinary group; and
wherein the determining at least one candidate edge server comprises:
determining an edge server with the server type group being the ordinary group of the edge servers comprised in the L edge computing nodes as the candidate edge server.

6. The service processing method according to claim 2, further comprising:
monitoring execution of the matching subtask of each edge server; and
reselecting, based on monitoring an exception in the execution of the matching subtask, a new edge server and executing the matching subtask of the new edge server.

7. The service processing method according to claim 2, wherein a subtask corresponds to an execution duration threshold, and
wherein the method further comprises:
receiving timeout prompt information reported by any edge server based on the any edge server not being able to execute the matching subtask, the timeout prompt information indicating that a duration required for the any edge server to execute the matching subtask is greater than an execution duration threshold corresponding to the matching subtask and indicating that a new edge server needs to be reallocated to execute the matching subtask of the new edge server.

8. The service processing method according to claim 1, wherein the first computing power resource comprises any one or more of the following: a graphics processing unit computing power resource, a central processing unit computing power resource, an internal memory, a network bandwidth, and a network throughput; and
wherein the graphics processing unit computing power resource comprises at least one of the following: floating-point operations per second of a graphics processing unit and operations per second of the graphics processing unit; and the central processing unit computing power resource comprises at least one of the following: floating-point operations per second of a central processing unit and operations per second of the central processing unit.

9. The service processing method according to claim 1, wherein the determining the first computing power resource comprises:
determining a computation complexity corresponding to a task type of the offline task based on a correspondence between the task type and the computation complexity;
finding at least one matching historical offline task from historical offline tasks according to the determined computation complexity based on a computation complexity corresponding to the at least one matching historical offline task matching the determined computation complexity; and
estimating a computing power resource required for the offline task based on the computing power resource for executing the at least one matching historical offline task, to obtain the first computing power resource required to execute the offline task.

10. A service processing apparatus, comprising:
at least one memory configured to store program code; and
at least one processor configured to access the at least one memory and operate according to the program code, the program code comprising:
determining code, configured to cause at least one of the at least one processor to determine a first computing power resource for executing an offline task; and determine N edge servers configured to execute the offline task and on which cloud applications are running, based on idle computing power resources of the N edge servers being greater than the first computing power resource, N being an integer greater than or equal to 1; and
scheduling code configured to cause at least one of the at least one processor to schedule the offline task to the N edge servers in a distributed mode while ensuring normal operation of the cloud applications, so that for each edge server in the N edge servers, the edge server executes the offline task using the idle computing power resource of the edge server.

11. The service processing apparatus according to claim 10, wherein the scheduling code is further configured to cause at least one of the at least one processor to:
divide the offline task into N subtasks based on the idle computing power resources of the N edge servers; and
respectively allocate the N subtasks to the N edge servers, so that each edge server in the N edge servers executes a corresponding subtask.

12. The service processing apparatus according to claim 10, wherein the cloud applications are deployed to M edge servers for execution, the M edge servers are allocated to P edge computing nodes, and each of the P edge computing nodes is deployed with one or more edge servers, M and P being integers greater than or equal to 1; and
wherein the determining code is further configured to cause at least one of the at least one processor to:
select L edge computing nodes from the P edge computing nodes such that node idle computing power resources of the L edge computing nodes are greater than the first computing power resource, the node idle computing power resource being obtained according to the idle computing power resources of the edge servers deployed in the each edge computing node;
determine at least one candidate edge server from edge servers comprised in the L edge computing nodes based on attribute information of each edge server comprised in the L edge computing nodes; and
determine the N edge servers from the at least one candidate edge server according to the idle computing power resource of each edge server in the at least one candidate edge server and the first computing power resource.

13. The service processing apparatus according to claim 12, wherein the attribute information comprises a working state of each edge server, and the working state comprises an idle state or a busy state; and
wherein the determining code is further configured to cause at least one of the at least one processor to:
determine an edge server with the working state being the idle state of the edge servers comprised in the L edge computing nodes as a candidate edge server.

14. The service processing apparatus according to claim 12, wherein the attribute information comprises a server type group to which each edge server belongs, and the server type group comprises a default whitelist group and an ordinary group; and
wherein the determining code is further configured to cause at least one of the at least one processor to:
determine an edge server with the server type group being the ordinary group of the edge servers comprised in the L edge computing nodes as the candidate edge server.

15. The service processing apparatus according to claim 11, wherein the program code further comprises:
processing code configured to cause at least one of the at least one processor to:
monitor execution of the matching subtask of each edge server; and
reselect, based on monitoring an exception in the execution of the matching subtask, a new edge server and execute the matching subtask of the new edge server.

16. The service processing apparatus according to claim 11, wherein a subtask corresponds to an execution duration threshold, and
wherein the program code further comprises:
receiving code configured to cause at least one of the at least one processor to receive timeout prompt information reported by any edge server based on the any edge server not being able to execute the matching subtask, the timeout prompt information indicating that a duration required for the any edge server to execute the matching subtask is greater than an execution duration threshold corresponding to the matching subtask and indicating that a new edge server needs to be reallocated to execute the matching subtask of the new edge server.

17. The service processing apparatus according to claim 10, wherein the first computing power resource comprises any one or more of the following: a graphics processing unit computing power resource, a central processing unit computing power resource, an internal memory, a network bandwidth, and a network throughput; and
wherein the graphics processing unit computing power resource comprises at least one of the following: floating-point operations per second of a graphics processing unit and operations per second of the graphics processing unit; and the central processing unit computing power resource comprises at least one of the following: floating-point operations per second of a central processing unit and operations per second of the central processing unit.

18. The service processing apparatus according to claim 10, wherein the determining code is further configured to cause at least one of the at least one processor to:
determine a computation complexity corresponding to a task type of the offline task based on a correspondence between the task type and the computation complexity;
find at least one matching historical offline task from historical offline tasks according to the determined computation complexity based on a computation complexity corresponding to the at least one matching historical offline task matching the determined computation complexity; and
estimate a computing power resource required for the offline task based on the computing power resource for executing the at least one matching historical offline task, to obtain the first computing power resource required to execute the offline task.

19. A non-transitory computer-readable storage medium, storing computer code which, when executed by at least one processor, causes the at least one processor to at least:
determine a first computing power resource for executing an offline task;
determine N edge servers configured to execute the offline task and on which cloud applications are running based on idle computing power resources of the N edge servers being greater than the first computing power resource, N being an integer greater than or equal to 1; and
schedule the offline task to the N edge servers in a distributed mode while ensuring normal operation of the cloud applications, so that for each edge server in the N edge servers, the edge server executes the offline task using the idle computing power resource of the edge server.

20. The non-transitory computer-readable storage medium to claim 19, wherein the schedule comprises:
dividing the offline task into N subtasks based on the idle computing power resources of the N edge servers; and
respectively allocating the N subtasks to the N edge servers, so that each edge server in the N edge servers executes a corresponding subtask.
